(19) United States
(12) Patent Application Publication
(10) Pub. No.: US 2026/0316549 A1
(43) Pub. Date: Oct. 15, 2026

(54) TRANSMISSION ASSEMBLY FOR A HYBRID DRIVE

(71) Applicant: GKN Automotive Limited, Birmingham (GB)

(72) Inventors: Lukasz Sedlak, Lohmar (DE); Thomas Schepanowski, Lohmar (DE)

(21) Appl. No.: 19/633,604

(22) Filed: Mar. 30, 2026

(30) Foreign Application Priority Data
Apr. 11, 2025 (DE) 102025114390.0

(51) Int. Cl. B60K 6/547; B60K 6/40; B60K 6/48

(52) U.S. Cl. CPC B60K 6/547; B60K 6/40; B60K 2006/4833

(57) ABSTRACT

A transmission assembly comprising a transmission housing, a generator shaft with generator gear, a stepped gearing that can be drivingly connected to an internal combustion engine, a reduction gearing that can be drivingly connected to an electric machine, a differential gearing with a differential input gear, which is engaged with a stepped gearing output gear and a reduction transmission output gear, wherein the generator gear is engaged with a drive gear of the stepped gearing, which forms a gear stage of the stepped gearing with an intermediate gear. The disclosure also relates to a hybrid assembly with such a transmission assembly.

### CROSS REFERENCE TO RELATED APPLICATIONS

This application claims priority to German Patent Application No. 102025114390.0 filed on Apr. 11, 2025, and the entire content of this priority application is incorporated herein by reference in its entirety.

### TECHNICAL FIELD

The disclosure relates to a transmission assembly for a hybrid drive for a motor vehicle and a hybrid drive with such a transmission assembly.

### BACKGROUND

A transmission unit for a hybrid motor vehicle is known from DE 10 2019 122 557 A1. The transmission unit comprises a first electric motor designed as a generator, a second electric motor designed as a prime mover, a transmission input shaft coupled to the first electric motor and an internal combustion engine, and a differential gearing which can be coupled to the transmission input shaft via at least two different transmission ratios. A rotor shaft of the second electric motor is operatively connected to the differential gearing by means of a coupling unit.

A hybrid drive system is known from CN 1 14 274 757 A, which comprises an input shaft, an internal combustion engine drivingly connected thereto via a clutch, and a first electric motor, an output shaft, a multi-speed gearbox arranged between the input shaft and the output shaft, a differential mechanism connected to the output shaft and a second drive motor drive-connected thereto. The clutch is designed as a friction disc clutch and the multi-speed gearbox is designed as a three-speed gearbox.

A vehicle drive transmission is known from EP 3 988 363 A1, corresponding to US 11 807 100 B2 or JP 2021 054289 A, which comprises a first drive element coupled to a rotary electric machine, a second drive element drivingly coupled to an internal combustion engine and a differential gear unit for distributing the rotary motion from a differential input gear to two output elements.

A transmission assembly for a hybrid drive is known from WO 2021/093930 A1, comprising a stepped gearing connectable to the internal combustion engine via a first and second shift stage, a reduction gearing connectable to the electric machine, a superimposing gearing which can superimpose a rotational motion introduced by the stepped gearing and a rotational motion introduced by the superimposing gearing and transmit it to a differential gear unit. The transmission assembly is also referred to as a multi-speed dedicated hybrid transmission (DHT). A multi-mode hybrid transmission (multi-mode DHT) is known from WO 2021/052557 A1, and a single-speed hybrid transmission (single-speed DHT) is known from WO 2021/089166 A1.

An object of at least some implementations of the present disclosure is to propose a transmission assembly for a hybrid drive with internal combustion engine, electric motor and generator, which is simple and compact in design. Furthermore, a hybrid drive assembly with such a transmission assembly is to be proposed.

### SUMMARY

As a solution, a transmission assembly for a hybrid drive with internal combustion engine, electric machine and generator is proposed, the transmission assembly comprising a transmission housing; a generator shaft rotatably mounted in the transmission housing about an axis of rotation; a stepped gearing with a stepped gearing input shaft rotatably mounted in the transmission housing about an input shaft axis of rotation, a first gear pair, a second gear pair, and a controllable shift clutch configured to selectively transmit a rotational motion from the stepped gearing input shaft via the first gear pair or the second gear pair to a stepped gearing output gear, or interrupt transmission of rotational motion; wherein the first gear pair comprises a first drive gear, which is non-rotatably connected to the input shaft, and a first intermediate gear, which is rotatably mounted on an intermediate shaft, and the second gear pair comprises a second drive gear, which is non-rotatably connected to the input shaft, and a second intermediate gear, which is rotatably mounted on the intermediate shaft; wherein the generator shaft comprises a generator gear, which is engaged with the first or second drive gear of the input shaft; a reduction gearing having a reduction gearing input shaft and adapted to slow down an input rotary motion to a reduction gearing output gear; wherein a controllable clutch is provided in the power path of the reduction gearing for selectively transmitting or interrupting a rotary motion; and a differential gearing having a differential input gear meshing with the stepped gearing output gear and the reduction gearing output gear, a first differential output part for driving a first side shaft and a second differential output part for driving a second side shaft.

An advantage of the transmission assembly is that it has a small number of parts and a compact design. The fact that the generator gear is in direct meshing engagement with one of the drive gears means that a separate pair of gears between the generator shaft and the transmission input shaft is not required. The drive gear meshing with the generator gear thus fulfils two functions, namely torque transmission to the generator shaft and to the intermediate shaft. Consequently, a gearwheel can be dispensed with, which has a favourable effect on the required installation space and weight. The generator shaft, stepped gearing input shaft and/or intermediate shaft can be arranged with their respective axis of rotation parallel to each other. The generator shaft is associated with the generator and can be drivingly connected thereto, respectively. The stepped gearing input shaft is assigned to the combustion engine, respectively can be drivingly connected thereto. The reduction gearing input shaft is assigned to the electric motor, respectively can be drivingly connected thereto.

The generator shaft is arranged parallel to the stepped gearing input shaft and is permanently drivingly connected thereto via the generator gear meshing with the drive gear. A generator connected to the transmission housing can thus be driven by an internal combustion engine to be connected to the input shaft and convert an input driving force into electrical energy. The electrical energy generated can be stored in a battery and later used to electrically drive the drive axle of the vehicle.

The stepped gearing can be designed as a two-step transmission, or in other words two-speed transmission. This means that a rotational motion can be transmitted from the stepped gearing input shaft to the stepped gearing output gear with exactly two, i.e. in particular with no more than two transmission ratios. The number of gears of the stepped gearing is preferably five, namely the first pair of gears, the second pair of gears and the stepped gearing output gear. The output gear preferably meshes directly with the differential input gear. The generator gear can be formed in one piece with the generator shaft, in particular in the form of an integral pinion. Furthermore, the stepped gearing input shaft may be provided with only the first and second drive gears, i.e. no other gears are connected to the shaft. Preferably, one of the two drive gears is integrally formed, i.e. is formed in one piece with the input shaft. The other of the two drive gears can be connected to the input shaft in a force-fit and/or form-fit manner, for example by means of an interference fit and/or shaft splines. The aforementioned features can contribute to a low number of parts, a low weight or reduced installation space requirements.

The connection area for the generator can be provided on the axially opposite side of the transmission housing, to which the combustion engine can be connected. In this case, the generator input shaft extends out of the transmission housing on the opposite housing wall to the combustion engine, which is also referred to as the generator-side side wall. The stepped gearing input shaft extends through the side wall of the housing on the engine side.

The first drive gear can be arranged closer to the side wall on the generator side than the second drive gear, which can be arranged closer to the side wall on the engine side. Furthermore, the first drive gear can be smaller than the second drive gear and, accordingly, the first intermediate gear can be larger than the second intermediate gear. With this configuration, the low gear stage is arranged adjacent to the side wall on the engine side, and the high gear stage is arranged adjacent to the side wall on the generator side. The generator gear preferably meshes with the smaller first drive gear and is thus also arranged axially on the side wall on the generator side.

According to an embodiment, the controllable clutch can be designed as a form-fit clutch. A form-fit clutch refers to clutches that achieve torque transmission by positive engagement of at least two clutch parts, and may also be designated positive-lock clutch. A form-fit clutch can be designed as a dog clutch, claw clutch or tooth clutch, for example, without being limited thereto. In an embodiment, the controllable clutch can comprise a shift hub, which is connected to the intermediate shaft in a rotationally fixed manner and is arranged axially between the first intermediate gear and the second intermediate gear. An axially movable coupling element can selectively connect the shift hub either to the first intermediate gear for transmitting a torque at a first speed or to the second intermediate gear for transmitting a torque at a second speed. The positive engagement can take place via a first coupling part assigned to the first intermediate gear or a second coupling part assigned to the second intermediate gear. The respective coupling part can, for example, be firmly connected to the associated intermediate gear and/or be designed in one piece with it. Torque transmission can be interrupted in an intermediate position. The coupling element can be designed in the form of a sliding sleeve, which is held on the shift hub in a rotationally fixed manner and is axially displaceable by means of a shift fork and a shift rod. The shift axis of the shift rod has a centre distance from the axis of rotation of the intermediate shaft that is preferably less than 1.5 times the radius of the first or larger intermediate gear. In this way, the tilting torques acting on the shift fork during shifting are relatively low, which has a favourable effect on the shifting accuracy and the required shifting force.

The stepped gearing output gear can be arranged axially adjacent to the first intermediate gear, in particular axially between the first intermediate gear and a bearing of the intermediate shaft. The two intermediate gears are rotatably mounted on the intermediate shaft, for example by means of needle bearings or plain bearings. An axial distance between the first intermediate gear and the second intermediate gear can be smaller than an axial length of the toothing of the stepped gearing output gear, in particular smaller than 0.8 times the axial length of the toothing of the stepped gearing output gear, which contributes to an axially shortened design.

Furthermore, the stepped gearing output gear can be arranged on the side of the transmission assembly facing the combustion engine, in particular axially between the first gear plane and the side wall of the housing on the engine side. Accordingly, the differential input gear meshing with the stepped gearing output gear can also be arranged axially adjacent to the pair of intermediate gears. The differential case or basket may have a flange portion, wherein the input gear may be arranged on the combustion engine-side housing wall at the flange portion. These features can individually or jointly contribute to a space-saving assembly of the differential in relation to the stepped gearing.

The transmission assembly can include a parking lock unit to lock the driveline in parking mode and prevent the vehicle from rolling away unintentionally. The parking lock unit can have a ratchet wheel that is rotationally fixedly connected to a rotatable component of the transmission assembly and a locking element that is designed to engage with the ratchet wheel in order to selectively lock or release it. In the closed state, the parking lock blocks a rotational movement of the differential, respectively the side shafts connected thereto. For this purpose, the component connected to the ratchet wheel is preferably in direct drive connection with the differential input gear, i.e. without an intermediate clutch or the like.

The parking lock unit can be arranged in the transmission assembly depending on the space requirements. According to a first possibility, the parking lock can be arranged in the power path of the combustion engine drive. In particular, the parking lock wheel can be connected to the intermediate shaft of the stepped gearing in a rotationally fixed manner, and thus have a direct drive connection with the differential. The parking lock wheel can, for example, be arranged axially between the second intermediate gear and the generator-side housing wall, in particular with axial overlap with the generator-side bearing of the transmission input shaft. According to a second possibility, the parking lock can also be arranged in the power path of the electric machine, in particular between the clutch and the differential.

The input shaft of the stepped gearing can be rotatably mounted in the transmission housing about an input shaft axis by means of first and second input shaft bearings, and the intermediate shaft can be rotatably mounted in the transmission housing about an intermediate shaft axis parallel to the input shaft by means of first and second intermediate shaft bearings. The first intermediate shaft bearing can be completely axially offset from the first input shaft bearing. Alternatively or additionally, the second intermediate shaft bearing can also be completely axially offset from the second input shaft bearing.

The above object is further solved by a hybrid drive comprising: an internal combustion engine; an electric machine; a generator; and a transmission assembly designed according to one or more of the above embodiments; wherein the stepped gearing input shaft is drivingly connected to the internal combustion engine, wherein the reduction gearing input shaft is drivingly connected to the electric machine, and further comprising a control unit for controlling the electric machine, the internal combustion engine, the generator, the shift clutch and the clutch.

The hybrid drive assembly has the same advantages as the transmission assembly, so that reference is made to the above description for the sake of brevity. All the features described in connection with the transmission assembly can be realised in the hybrid drive assembly.

The hybrid drive assembly can realise various operating modes. For example, in a first shift position of the stepped gearing, torque is transmitted from the internal combustion engine to the drive axle with a first transmission ratio (first gear). In the second shift position, the stepped gearing transmits torque to the drive axle with a second transmission ratio (second gear). In the neutral position or open position of the clutch, the power path between the internal combustion engine and the differential is interrupted. The electric motor can be variably controlled in both gears, so that the two drive sources jointly drive the drive axle in a superimposed manner. It is also possible for the electric motor or the internal combustion engine to drive the reduction gearing, respectively the drive axle alone. To do this, the clutch must be opened in the other power path.

The hybrid drive assembly can also include a storage assembly that is to be electrically connected to the generator for storing electrical energy, and can thus also be referred to as electrical energy storage. The generator is a second electrical machine of the drive assembly. The generator can be permanently connected to the drive shaft of the combustion engine and, in neutral mode, run idle or, in generator mode, generate electricity. The power of the electric motor can be less than the power of the combustion engine and/or the power of the generator can be less than the power of the electric motor.

### BRIEF DESCRIPTION OF THE DRAWINGS

Certain embodiments are explained below with reference to the drawing figures. Herein it shows:

FIG. 1A a transmission assembly, respectively hybrid assembly for a drive axle of a motor vehicle in a first embodiment in a sectional view through the axes of rotation;

FIG. 1B the transmission assembly from FIG. 1A in an axial view;

FIG. 1C the transmission assembly of FIG. 1A in a perspective view, partially sectioned;

FIG. 1D a detail of the clutch from FIG. 1A;

FIG. 2A a transmission assembly or hybrid assembly for a drive axle of a motor vehicle in a second embodiment in plan view;

FIG. 2B the transmission assembly from FIG. 2A in a first axial view with parts of the transmission housing;

FIG. 2C the transmission assembly of FIG. 2A in a second axial view without transmission housing;

FIG. 2D the transmission assembly of FIG. 2A in a first perspective view with parts of the transmission housing; and

FIG. 2E the transmission assembly of FIG. 2A in a second perspective view without transmission housing.

### DETAILED DESCRIPTION

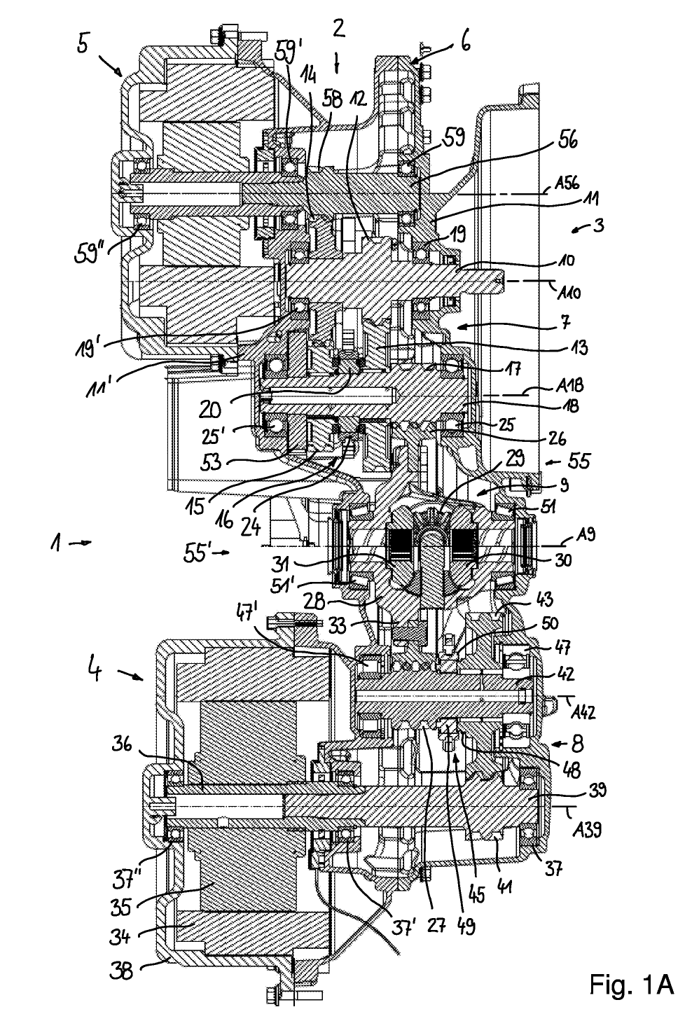

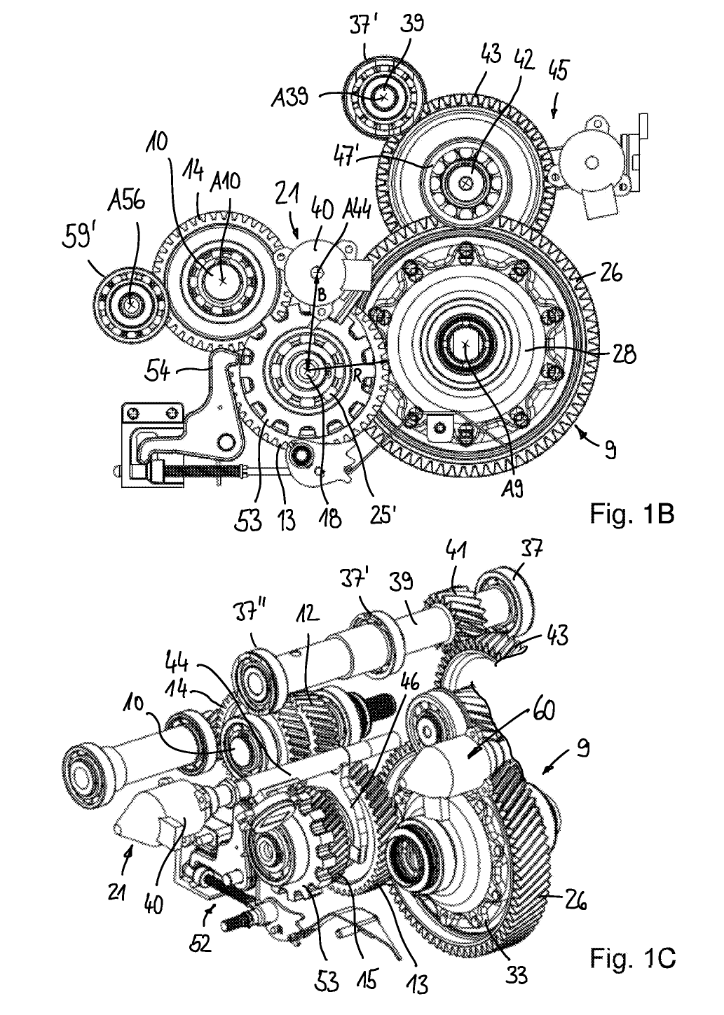

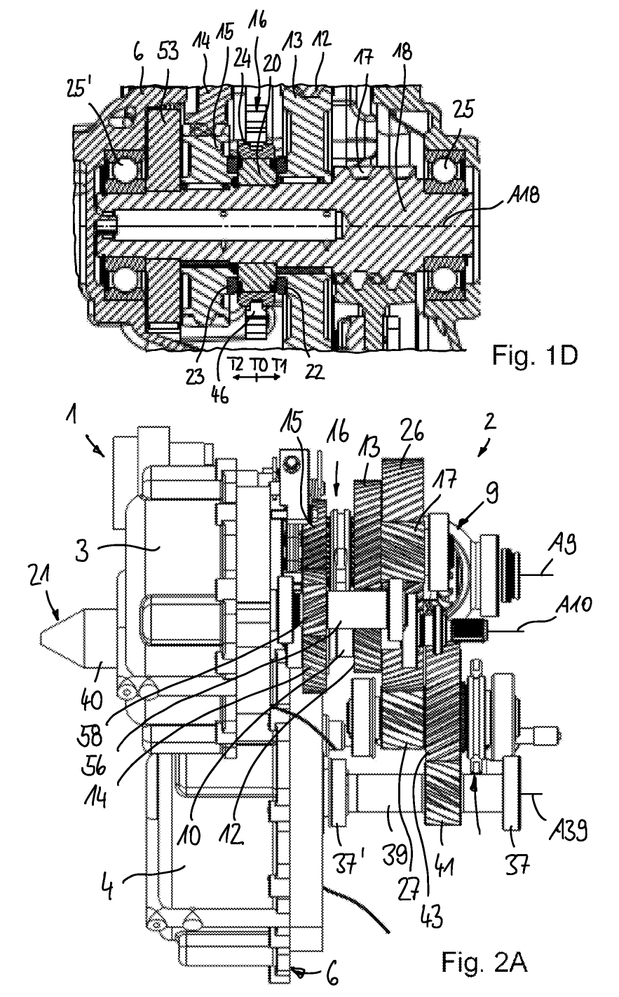

FIGS. 1A to 1D, which are described together below, show a transmission assembly 2 or hybrid drive assembly 1 for driving a vehicle axle. The hybrid drive assembly 1 comprises an internal combustion engine 3, an electric machine 4, a second electric machine in the form of a generator 5 and the transmission assembly 2.

The transmission assembly 2 is designed to transmit a first drive torque from the internal combustion engine 3 and/or a second drive torque from the electric machine 4 to a drive axle of the vehicle. Furthermore, the transmission assembly 2 can transmit drive power introduced by the internal combustion engine 3 to the generator 5. The generator 5 converts the mechanical energy into electrical energy, which can then be stored in a battery and later used for electrical propulsion by means of the electric motor 4. The transmission assembly 2 has a transmission housing 6, a first transmission unit in the form of a stepped gearing 7 assigned to the internal combustion engine, a second transmission unit in the form of a reduction gearing 8 assigned to the electric machine, and a differential gearing 9, which is drivingly connected to the stepped gearing 7 and the reduction gearing 8.

The stepped gearing 7 enables power transmission from the combustion engine to the differential gearing 9 with different transmission ratios or interruption of the power transmission. A controllable shift clutch 16, which can also be referred to as a shift unit, is provided for shifting. In particular, the stepped gearing 7 has an input shaft 10, which is mounted in the transmission housing 6 so as to be rotatable about an axis of rotation A10 and can be drivingly connected to the internal combustion engine 3, a first pair of gears 12, 13, which form a first gear plane, and a second pair of gears 14, 15, which form a second gear plane, and the controllable shift clutch 16. The shift clutch 16 is configured to transmit a rotational motion from the input shaft 10 optionally via the first gears 12, 13 or the second gears 14, 15 to an output gear 17, or to interrupt a transmission of the rotational motion. The output gear 17 is arranged axially outside a space formed between the first and second gearwheel planes.

The first pair of gears comprise a first drive gear 12, which is fixedly connected to the input shaft 10, in particular formed integrally therewith, and a first intermediate gear 13, which is rotatably mounted on an intermediate shaft 18 parallel to the input shaft 10. The intermediate shaft can also be referred to as a countershaft. The second pair of gears comprises a second drive gear 14, which is connected to the input shaft 10 in a rotationally fixed and axially fixed manner, and a second intermediate gear 15, which is rotatably mounted on the intermediate shaft 18. The first drive gear 12 is smaller than the second drive gear 14, and the first intermediate gear 13 is larger than the second intermediate gear 15. In this way, the first pair of gears can form a first gear stage and the second pair of gears can form a second gear stage. The shift clutch 16 is arranged axially between the first and second intermediate gears 13, 15. The axial distance formed between the first and second intermediate gears 13, 15 can be smaller than an axial length of the toothing of the output gear 17. The output gear 17 is arranged axially adjacent to the first intermediate gear 13, and/or axially between gear 13 and the side wall of the housing through which the input shaft 10 extends.

The transmission assembly 2 also has a generator shaft 56, which is rotatably mounted in the housing 6 via bearings 59, 59' on an axis of rotation A56 parallel to the stepped gearing input shaft 10. The generator shaft 56 comprises a generator gear 58, which is in meshing engagement with the larger second drive gear 14, so that the generator shaft is permanently drivingly connected to the input shaft 10. The generator gear 58 is designed in the present case as an integral pinion with the generator shaft 56, although a separate design is also possible. The generator 5 is arranged on the opposite side 55' of the transmission housing 6 to the combustion engine. Accordingly, the generator shaft 56 extends out of the transmission housing on this side 55'.

The input shaft 10 can be arranged coaxially to the engine shaft of the internal combustion engine and permanently connected thereto in a rotationally fixed manner. The input shaft 10 is rotatably mounted in the stationary housing 6 about the first axis of rotation A10 by means of first and second bearing means 19, 19'.

The intermediate shaft 18 is rotatably mounted in the housing 6 by means of bearing means 25, 25' about the axis of rotation A18, which runs parallel to the axis of rotation A10 of the input shaft 10. The first intermediate shaft bearing 25 is arranged in the housing so as to be partially axially offset in relation to the first input shaft bearing 19. Furthermore, the second intermediate shaft bearing 25' is arranged axially adjacent to the second intermediate gear 15 and is completely axially offset with respect to the second input shaft bearing 19'. The intermediate shaft 18 can be provided with a longitudinal bore and several transverse bores for supplying lubricant to the bearing sections for the first intermediate gear 13 and the second intermediate gear 15, which are rotatable thereon. A shift hub 20 is provided axially between the first intermediate gear 13 and the second intermediate gear 15, which is firmly connected to the intermediate shaft 18 and can also be referred to as output part.

The shift clutch 16 can be controlled by a shift unit 21, which can also be referred to as an actuator. Depending on the switching position (T0, T1, T2) of the shift clutch 16, several switching stages can be realised. A first gearshift stage is formed by the first pair of gears (12, 13) to transmit rotary motion with a low first transmission ratio i1 (first gear). A second gearshift stage is formed by the second pair of gears (14, 15) in order to transmit rotary motion with a higher second transmission ratio i2 (second gear). In a neutral position (T0), both intermediate gears 13, 15 are uncoupled from the shift hub 20 and the intermediate shaft 18, respectively.

The shift clutch 16, which is shown as a detail in FIG. 1D, comprises a first clutch part 22 connected to the first intermediate gear 13 in a rotationally fixed manner, a second clutch part 23 connected to the second intermediate gear 15 in a rotationally fixed manner, and a coupling element 24, which can optionally couple the shift hub 20 to the first or second clutch part 22, 23 for transmitting a torque. The coupling element 24 is designed in particular in the form of a sliding sleeve, which is held in a rotationally fixed manner on the shift hub 20 and can be axially displaced relative thereto by the shift unit 21. In a neutral position (T0), the sliding sleeve is freely rotatable relative to the first and second coupling parts 22, 23, in the first switching position (T1) it is connected to the first coupling part 22 in a rotationally fixed manner, and in the second switching position (T2) it is connected to the second coupling part 23 in a rotationally fixed manner. The shift unit 21 comprises a drive 40, which transmits a drive force to the sliding sleeve 24 via a shift rod 44 and a shift fork 46. A special feature of the present transmission assembly 2 is that the shift rod 44, viewed in cross-section, is arranged in a central region, in particular in a space located between the axis of rotation A10 of the input shaft 10, the axis of rotation A9 of the differential 9 and the axis of rotation A4 of the electric machine 4. In particular, the shift axis of the shift rod 44 can have a centre distance from the axis of rotation A18 of the intermediate shaft 18 that is less than 1.5 times the radius of the first intermediate gear 13. This means that the tilting moments acting on the shift fork during shifting are relatively low, resulting in favourable packaging. The shift unit can be arranged coaxially to the shift rod 44 and can be actuated electromechanically, electromotively, electromagnetically, hydraulically or pneumatically, for example.

The intermediate shaft 18 is arranged parallel to an axis of rotation A8 of the reduction gearing 8 and/or an axis of rotation A9 of the differential gearing 9. For power transmission, the output gear 17 of the stepped gearing 7 is in meshing engagement with the input gear 26 of the differential gearing 9. The input gear 26 of the differential, which is designed in particular in the form of a ring gear, is also in meshing engagement with the output gear 27 of the reduction gearing 8. In this way, drive power from the stepped gearing and/or the reduction gearing can be introduced into the differential.

The output gear 17 of the stepped gearing 7 is arranged in particular on the side of the transmission assembly 2 facing the combustion engine, preferably axially between the first gear plane and the side wall 11 of the housing 6, through which the input shaft 10 extends. Accordingly, the input gear 26 of the differential gear 9, which meshes with the output gear 17, is also arranged axially adjacent to the pair of intermediate gears 13, 15.

The differential gearing 9 is intended to split a drive torque, respectively rotary motion introduced by the stepped gearing or reduction gearing and transmit it to the right and left side shafts of the vehicle axle. For this purpose, the differential gearing comprises a differential case 28, several differential gears 29, which rotate together with the differential case 28 around the axis of rotation A9, as well as two side shaft gears, which are meshed with the differential gears 28 and serve as output parts 30, 31 of the differential. The side shaft gears are to be connected via a respective side shaft (not shown) for torque transmission. The differential case 28 may have a flange portion 33, with the input gear 26 in this embodiment being disposed on the side of the flange facing the side wall 11 of the housing on which the internal combustion engine is to be disposed.

A second power path is formed by the reduction gearing 8 to transmit drive torque to the differential case 28 via the input gear 26. The reduction gearing 8 is to be drivingly connected to an electric machine 4. The electric machine 4 has, in particular, a stator 34 and a rotor 35 rotatable relative thereto, which drives a motor shaft 36 in rotation when the machine is energised. The motor shaft 36 is rotatably mounted in a motor housing 38 about the axis of rotation A4 by means of bearing means 37, 37'. The rotational motion of the motor shaft 36 is transmitted to the input shaft 39 of the reduction gearing 8. The electric machine 4 can be supplied with electric current from a battery, whereby the battery can be charged by the electric machine 4 in generator mode. The electric machine 4 and/or the internal combustion engine 3 can be controlled by means of power electronics, such as a pulse inverter, with an integrated electronic control unit (ECU).

The reduction gearing 8 is designed to convert the rotary motion introduced from the electric machine 4 to the input shaft 39 from high speed to slow speed. The reduction gearing 8 comprises a. first transmission stage, formed by a drive gear 41 firmly connected to the input shaft 39, in particular formed in one piece with the latter, and an intermediate gear 43 formed as a loose gear and rotatably mounted on an intermediate shaft 42. The drive gear 41 and the intermediate gear 43 are in meshing engagement with one another and form a first gear set with a first transmission ratio. The second transmission stage comprises the output gear 27 of the reduction gearing 8, which is fixedly connected to the intermediate shaft 42, and the input gear 26 of the differential meshing therewith, which forms a second gear set with a second transmission ratio.

The input shaft 39 is rotatably mounted in the housing 6 about the axis of rotation A39 by bearing means 37, 37'. The intermediate shaft 42 is rotatably mounted on a parallel axis of rotation A42 in the housing 6 via associated bearing means 47, 47'. A controllable clutch 45 is provided in the power path of the reduction gearing 9 to selectively transmit or interrupt a rotational motion.

The clutch 45 is designed in particular as a form-fit, i.e. positive-locking clutch and can be transferred into a closed or open position by an electrically controllable actuator 60. The clutch 45 comprises a first clutch part 49, which is connected to the intermediate shaft 42 in a rotationally fixed manner, and a second clutch part 48, which is fixedly connected to the intermediate gear 43, in particular designed as a single piece therewith, as well as a coupling element 50. The coupling element 50 is designed in the form of a sliding sleeve, which is held rotationally fixed on the first clutch part 48 and is axially displaceable relative thereto by means of the actuator 60. An axial movement generated by the actuator 60 is transmitted via a shift rod 57 to a shift fork 61, which engages with the sliding sleeve 62. Through the form-fitting engagement of the coupling element 50 with the intermediate gear 43, the latter is fixed to the intermediate shaft in a rotationally fixed manner, so that torque is transmitted from the electric motor to the differential.

The transmission assembly 2 includes an optional parking lock unit 52. The parking lock unit 52 has a ratchet wheel 53, which is firmly connected to the intermediate shaft 18, and a locking element 54, which is designed to engage in the ratchet wheel 53 in order to lock or release it. In the present case, the ratchet wheel 53 is arranged axially between the second intermediate gear 15 and the housing wall on the generator side, without being restricted thereto. The locking element 54 is thus in direct rotational connection with the differential input gear 26, which means that the differential is locked when the parking lock unit is closed.

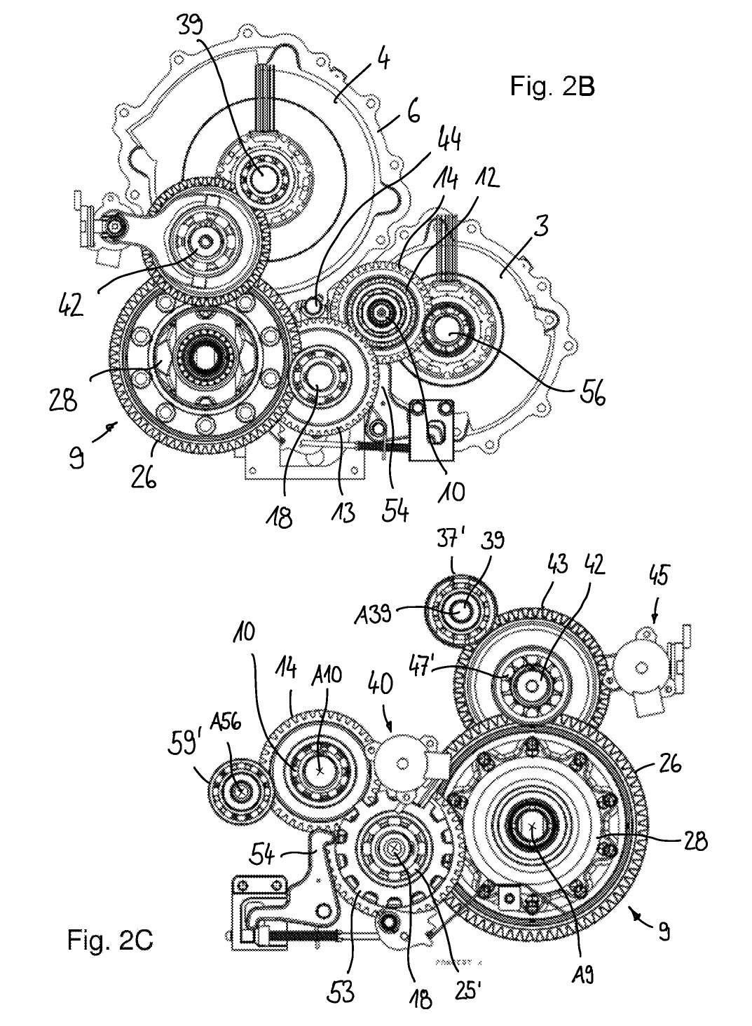

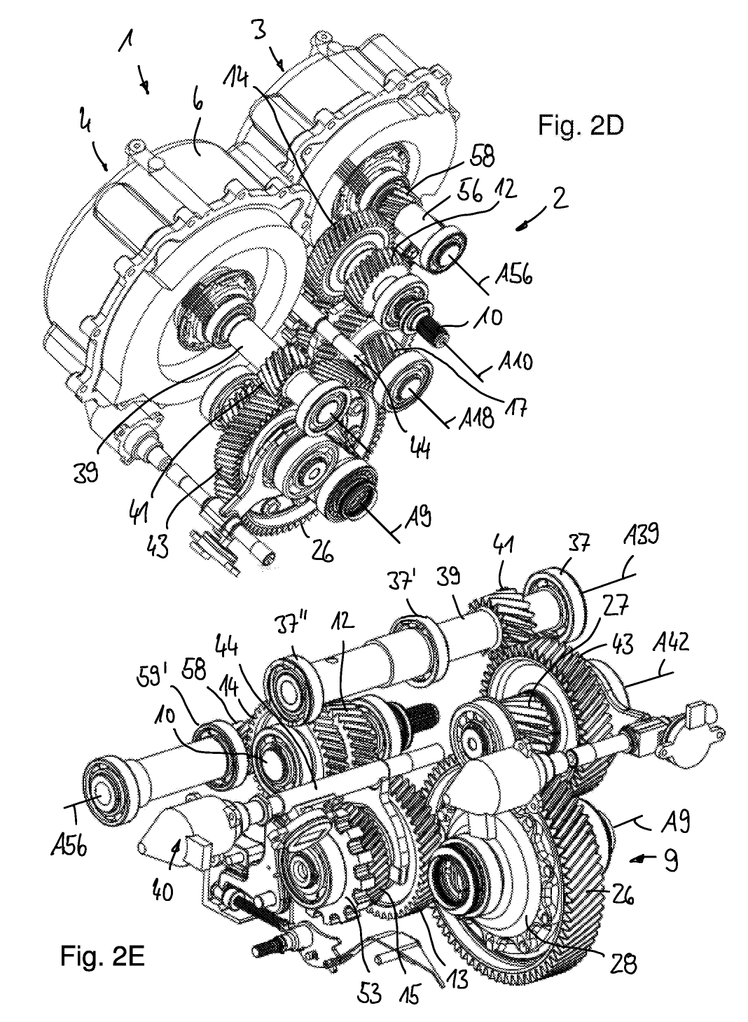

FIGS. 2A to 2E, which are described together below, show a hybrid assembly 1, respectively transmission assembly 2 in a modified embodiment. In terms of its structure and mode of operation, this largely corresponds to the embodiment shown in FIG. 1, so that reference is made to the above description with regard to the similarities. The same and/or corresponding details are labelled with the same reference numbers as in FIG. 1.

A difference is the arrangement of the coupling 45 of the reduction gearing 8, which in the present embodiment is arranged axially between the intermediate gear 43 and the bearing 47. The coupling element 50 is designed in the form of a sliding sleeve, which is seated on the coupling part 48 in a rotationally fixed and axially movable manner and can be displaced into the closed or open position as desired by means of the actuator.

The embodiments described have the advantage that they are simple and compact in design.

Certain embodiments or components or features of components have been noted herein as being "preferred" and some options as being “preferable” or the like and such indications are to be understood as relating to a preference of the applicant at the time this application was filed. Such embodiments, components or features noted as being "preferred" or “preferable” or the like are optional and are not required for implementation of the innovations disclosed herein unless otherwise indicated as being required, or specifically included within the claims that follow.

1. A transmission assembly for a hybrid drive comprising an internal combustion engine, an electric machine and a generator, the transmission assembly comprising:
a transmission housing,
a generator shaft which is mounted in the transmission housing so as to be rotatable about a drive shaft axis,
a stepped gearing with a stepped gearing input shaft rotatably mounted in the transmission housing about an input shaft axis, a first pair of gears, a second pair of gears, and a controllable shift clutch configured to selectively transmit a rotational motion from the stepped gearing input shaft via the first pair of gears or the second pair of gears to a stepped gearing output gear, or to interrupt transmission of the rotational motion,
wherein the first pair of gears comprises a first drive gear non-rotatably connected to the input shaft, and a first intermediate gear rotatably mounted on an intermediate shaft parallel to the input shaft, and the second pair of gears comprises a second drive gear non-rotatably connected to the input shaft, and a second intermediate gear rotatably mounted on the intermediate shaft,
wherein the generator shaft has a generator gear engaged with one of the first drive gear or the second drive gear,
a reduction gearing comprising a reduction gearing input shaft and configured to transfer an applied rotational motion to a reduction gearing output gear at a reduced speed; wherein a controllable clutch is provided in a power path of the reduction gearing to selectively transmit or interrupt rotational motion; and
a differential gearing comprising a differential input gear that meshes with the stepped gearing output gear and the reduction gearing output gear, and comprising a first differential output part for driving a first side shaft and a second differential output part for driving a second side shaft.

2. The transmission assembly according to claim 1, wherein the generator shaft extends through a generator-side side wall of the housing, and the stepped gearing input shaft extends through an engine-side side wall of the housing, which is opposite the generator-side side wall,
wherein the second drive gear is arranged closer to the generator-side side wall than the first drive gear, which is arranged closer to the engine-side side wall, and
wherein the generator gear is engaged with the second drive gear.

3. The transmission assembly according to claim 1, wherein the first drive gear is smaller than the second drive gear, and the first intermediate gear is larger than the second intermediate gear.

4. The transmission assembly according to claim 1, wherein the generator gear is formed in one piece with the generator shaft.

5. The transmission assembly according to claim 1, wherein the stepped gearing input shaft only comprises the first drive gear and the second drive gear, with the generator gear being engaged with the second drive gear.

6. The transmission assembly according to claim 1, wherein the stepped gearing is designed as a two-speed transmission such that a rotational motion can be transmitted from the stepped gearing input shaft to the stepped gearing output gear with exactly two transmission ratios, wherein the stepped gearing output gear is directly engaged with the differential input gear.

7. The transmission assembly according to claim 1, wherein one of the first drive gear and the second drive gear is formed integrally with the stepped gearing input shaft, and the other one of the first drive gear and the second drive gear is produced separately and is firmly connected to the stepped gearing input shaft.

8. The transmission assembly according to claim 1, wherein the controllable shift clutch is designed as a form-fit clutch and comprises a shift hub connected non-rotatably to the intermediate shaft and arranged axially between the first intermediate gear and the second intermediate gear, as well as a first clutch part associated with the first intermediate gear, a second clutch part associated with the second intermediate gear and a coupling element that can selectively couple the shift hub to the first clutch part or the second clutch part for transmitting a torque.

9. The transmission assembly according to claim 8, wherein the coupling element is designed as a sliding sleeve that is held in a rotationally fixed manner on the shift hub and that is axially displaceable by a shift fork and a shift rod, and wherein the shift axis of the shift rod has an axis distance from the axis of rotation of the intermediate shaft which is less than 1.5 times the radius of the first intermediate gear.

10. The transmission assembly according to claim 1, wherein the reduction gearing has a gear stage with a drive gear connected to the reduction gearing input shaft and an intermediate gear rotatably mounted on a reduction gearing intermediate shaft, wherein the controllable clutch is arranged axially between the gear stage and the reduction gearing output gear and is configured to selectively connect or disconnect the intermediate gear to or from the reduction gearing intermediate shaft.

11. The transmission assembly according to claim 1, wherein the stepped gearing output gear is arranged axially between the first intermediate gear and a bearing of the intermediate shaft, and in that the stepped gearing output gear is arranged axially outside a space which is formed between a first gear plane and a second gear plane, and wherein an axial distance between the first intermediate gear and the second intermediate gear is smaller than an axial length of the toothing of the stepped gearing output gear.

12. The transmission assembly according to claim 1, further comprising a parking lock unit with a ratchet wheel that is non-rotatably connected to a rotatable component of the transmission assembly, and a locking element configured to engage the ratchet wheel to selectively lock or release it, and wherein the ratchet wheel is arranged axially between a differential input gear plane and the generator-side side wall of the housing, wherein the ratchet wheel of the parking lock unit is arranged on the stepped gearing intermediate shaft.

13. The transmission assembly according to claim 12, wherein the stepped gearing input shaft is rotatably mounted in the transmission housing about an input shaft axis by means of first and second input shaft bearings, and the stepped gearing intermediate shaft is rotatably mounted in the transmission housing about an intermediate shaft axis by means of first and second intermediate shaft bearings,
wherein at least one of the first and second intermediate shaft bearings is completely axially offset from the first and second input shaft bearings associated with the same housing side, and
wherein the second input shaft bearing has at least partial axial overlap with the ratchet wheel.

14. The transmission assembly according to claim 1 in a hybrid drive assembly, the hybrid drive assembly comprising:
an internal combustion engine;
an electric machine; and
a generator,
wherein the stepped gearing input shaft of the transmission assembly is drivingly connected to the internal combustion engine,
wherein the reduction gearing input shaft is drivingly connected to the electric machine,
wherein the generator shaft is drivingly connected to the generator, and
wherein a control unit is provided for controlling the electric machine, the internal combustion engine, the generator, the controllable shift clutch and the controllable clutch.
